(19) United States
(12) Patent Application Publication
(10) Pub. No.: US 2004/0261129 A1
(43) Pub. Date: Dec. 23, 2004

(54) User terminal for interactive digital telebroadcasting system

(75) Inventor: Jean-Pierre Lagarde, Laval (FR)

Correspondence Address: FLEIT, KAIN, GIBBONS, GUTMAN, BONGINI, & BIANCO P.L., ONE BOCA COMMERCE CENTER, 551 NORTHWEST 77TH STREET, SUITE 111, BOCA RATON, FL, 33487, US

(73) Assignee: STMICROELECTRONICS SA, MONTROUGE (FR)

(21) Appl. No.: 10/765,455

(22) Filed: Jan. 27, 2004

(30) Foreign Application Priority Data
Jan. 28, 2003 (FR) 0300913

(51) Int. Cl. H04N 7/173; H04N 7/16

(52) U.S. Cl. 725/136; 725/132; 348/468; 348/461; 725/135

(57) ABSTRACT

A terminal for interactive telebroadcasting system comprising on the one hand a unit for adaptation to the physical telebroadcasting medium and on the other hand a control unit. The first unit comprises a receiver for receiving of a telebroadcast signal and for producing downstream information extracted from the signal, a transmission time based generator for generation of a transmission time base from the downstream information and a transmitter for transmission of a return signal, which are clocked as a function of the transmission time base. The second unit comprises a calculation unit having means of generating upstream information. The calculation unit is clocked as a function of the transmission time base.

### CROSS-REFERENCE TO RELATED APPLICATIONS

This application is based upon and claims priority from prior French Patent Application No. 0300913, filed on Jan. 28, 2003 the entire disclosure of which is herein incorporated by reference.

### FIELD OF THE INVENTION

The present invention generally relates to interactive digital telebroadcasting (“Digital Video Broadcasting” or DVB), in particular by satellite, by cable, or by terrestrial transmission.

### BACKGROUND OF THE INVENTION

It finds applications, in particular, in terminals, also referred to as decoder boxes (or STB standing for “Set-Top Box”) for telebroadcasting systems. In these systems, the trend over the last few years has been to introduce interactive services. STBs are thus becoming i-STBs (“interactive STBs”).

Several standards for the transmission of telebroadcast digital information are currently known. For telebroadcasting by satellite, the following are thus known in particular: the DVB-RCS (“DVB-Return Channel Satellite”), ESW (“EuroSkyWay”), HB6 (“Hot Bird 6”) standards, and the iTV-RCS (“interactive Television-Return Channel Satellite”) standard for interactive television. For cable telebroadcasting, the following standards are known in particular: DC2 (“DigiCypher 2”), DOCSIS (“Data Over Cable Services Interfaces Specifications”), and DVB-RCC (“DVB-Return Channel Cable”). For terrestrial telebroadcasting, the DVB-RCT (“DVB-Return Channel Terrestrial”) standard is known in particular.

The interactivity of the system is conveyed by a bidirectional channel between the source of telebroadcast data and the user terminal or the user terminals. From the point of view of the user terminal, this bidirectional channel comprises a downstream channel, through which the telebroadcast signal is received, and an upstream channel or return channel for the transmission of a return signal. The telebroadcast signal contains downstream data, for example multimedia data corresponding to one or more audiovisual programs. The return signal contains upstream data, for example codes corresponding to votes with regard to a televised game, identification and/or payment data with regard to pay-per-view television, and more.

By way of illustration, FIG. 1 diagrammatically shows an exemplary interactive satellite-based digital telebroadcasting network. A server 10 of a multimedia services provider comprises, in addition to the means necessary for its operation, a “Return Channel Satellite Terminal” or RCST 11 comprising means for despatching a telebroadcast signal SP1 to a satellite 20. The signal SP1 contains, in a downstream payload channel, the payload data (for example MPEG packets in regard to telebroadcast television) intended, ultimately, for at least one user terminal 30. In addition to the payload channel, the signal SP1 contains a downstream interactive channel. The latter channel contains return signaling data allowing access to the interactive network and synchronization of user terminals. The signal SP1 in the interactive channel is for example a signal satisfying the specifications of the DVB-RCS standard.

When the downstream interactive channel is multiplexed with the downstream payload channel on the same carrier, the application is said to be “In-Band” or IB. Such is the case for the DVB-RCS standard illustrated by FIG. 1. When on the contrary the downstream interactive channel is not multiplexed with the downstream payload channel but follows a different physical path (for example via a data transmission network), the application is said to be “Out Of Band” or OOB. Such is the case for the DVB-RCC standard.

Represented in FIG. 1 is a single user terminal 30 but it is of course understood that a plurality of such terminals may exist in the zone (or zones) of coverage of the satellite 20. Each user terminal comprises an RCST 31 for receiving a telebroadcast signal UT1 dispatched by the satellite 20. The RCST 31 also allows the user terminal 30 to dispatch a return signal UT2 to the satellite 20 in a multiplexed return channel. The signal UT2 is for example in accordance with the DVB-RCS standard.

The satellite 20 comprises a regenerator multiplexer for dispatching the telebroadcast signal UT1 to the user terminals 30, and for dispatching a return signal SP2 to the server 10. The signal UT1 contains in particular the payload data and the signaling data received by the satellite in the signal SP1. The signal SP2 results from the frequency- and time-multiplexing of the return signals UT2 received from the user terminals, in particular. The satellite 20 also comprises means for receiving in the return channel the return signals UT2 dispatched by the user terminals such as 30.

Each user terminal comprises means of adaptation to the physical medium. The physical medium comprises the space situated between Earth and the satellite in regard to satellite-based telebroadcasting, the cable in regard to telebroadcasting by cable and the radio broadcast space (atmosphere) in regard to terrestrial telebroadcasting. These means of adaptation form what is referred to as the physical layer in a layered architecture model such as the OSI model (standing for “Open Systems Interconnect”) of the ISO (“International Standards Organization”). Of course, the nature of these means depends on the standard of the interactive network, this standard being able to be any one of the types mentioned in the introduction, or the like.

Furthermore, each user terminal also comprises means affording control of access to the physical medium that form what is, in the aforesaid model, conventionally referred to as the physical medium access control layer (or MAC layer standing for “Media Access Control” layer). Finally, it may comprise higher layers, corresponding in particular to what is referred to as the “application” layer and the “user” layer in the aforesaid model.

Interactive satellite-based digital telebroadcasting networks working across a multitude of different telebroadcasting standards, which each constrain the clocking of the physical layer in a respective manner, the terminals do not exhibit synchronization between the physical layer on the one hand and the MAC layer and the higher layers on the other hand.

In particular, the transmission of upstream data over the return channel is based on the exchange of semaphores between the MAC layer and the physical layer, and on the use of a technique for obtaining in advance the data to be transmitted.

For the semaphore technique requires the availability of a large buffer memory capacity in the physical layer for storing the data to be transmitted before the instant of their actual transmission. This semaphore technique also necessitates, because of this in particular, complicated hardware architecture. Still further, this semaphore technique actually limits the bit rate on the upstream channel to around 2 Mbps (megabits per second) for the current processors of a decoder box, the buffer memory increasing with the bit rate.

Accordingly, a need exists to overcome the drawback and shortcomings of the prior art and to provide an improved terminal for interactive telebroadcasting system conforming to at least one specified telebroadcasting standard.

### SUMMARY OF THE INVENTION

Briefly, in accordance with the present invention, disclosed is a terminal for interactive telebroadcasting system conforming to at least one specified telebroadcasting standard. The terminal comprising on the one hand a unit for adaptation to the physical telebroadcasting medium having:

means of reception of a telebroadcast signal, producing downstream information extracted from the signal;

means of generation of a transmission time base from the downstream information;

means of transmission of a return signal, which are clocked as a function of the transmission time base;

and on the other hand a control unit comprising a calculation unit having means of generating upstream information, the calculation unit being clocked as a function of the transmission time base.

As has thus been understood, the unit for adaptation to the physical telebroadcasting medium affords the functionalities of the physical layer, and the control unit affords the functionalities of the MAC layer and of the higher layers. Only the unit for adaptation to the physical medium depends on the standard.

The MAC layer thus being synchronized with the physical layer, the transmission of the upstream data takes place in just-in-time mode. The buffer memory requirements are therefore greatly reduced. The bit rate of the uplink is no longer limited by the interaction between the MAC layer and the physical layer. Trials have shown that bit rates of the order of 100 Mbps may easily be obtained.

### BRIEF DESCRIPTION OF THE DRAWINGS

The subject matter, which is regarded as the invention, is particularly pointed out and distinctly claimed in the claims at the conclusion of the specification. The foregoing and other features, and advantages of the invention will be apparent from the following detailed description taken in conjunction with the accompanying drawings in which:

FIG. 1, already analyzed, is a diagram of an exemplary interactive satellite-based telebroadcasting system;

FIG. 2 is a schematic diagram of an exemplary terminal according to the invention;

FIGS. 3a to 3c are timing diagrams of signals illustrating the operation of an exemplary synchronization interface protocol between the unit for adaptation to the physical telebroadcasting medium and the control unit; and

FIGS. 4a to 4d are timing diagrams of signals illustrating the operation of an upstream data interface protocol between the unit for adaptation to the physical telebroadcasting medium and the control unit.

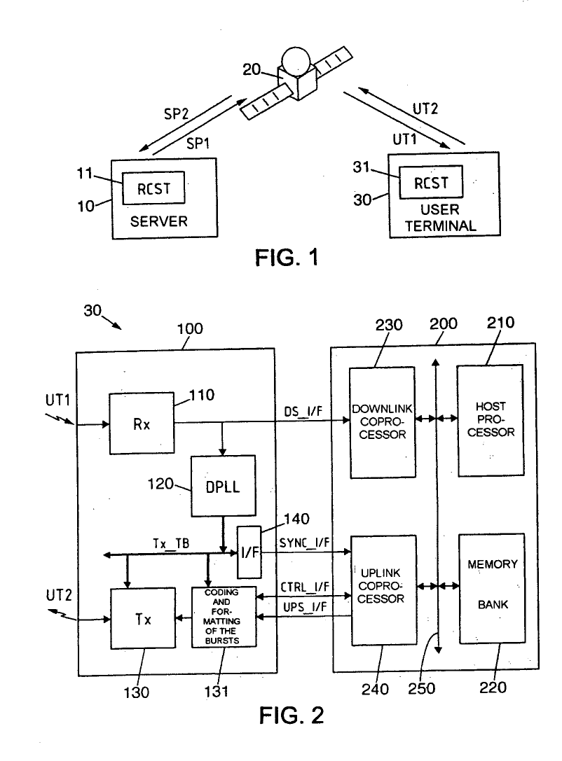

### DESCRIPTION OF THE PREFERRED EMBODIMENTS

It should be understood that these embodiments are only examples of the many advantageous uses of the innovative teachings herein. In general, statements made in the specification of the present application do not necessarily limit any of the various claimed inventions. Moreover, some statements may apply to some inventive features but not to others. In general, unless otherwise indicated, singular elements may be in the plural and vice versa with no loss of generality.

An exemplary embodiment of a terminal according to the invention is described diagrammatically in FIG. 2. A terminal suitable for use in a specified interactive telebroadcasting system is shown. The system conforms to a specified telebroadcasting standard, in particular one of those given in the introduction.

In what follows, the terms “upstream” and “downstream” are used with reference to the terminal. Namely, the terminal receives a signal UT1 (telebroadcast signal) comprising a downstream interactive channel, and transmits a return signal UT2, corresponding to an upstream interactive channel (return channel).

The terminal 30 comprises on the one hand a unit 100 for adaptation to the physical telebroadcasting medium, and on the other hand a control unit 200. If a conventional layered architecture model is considered, the unit 100 corresponds to the physical layer, and the unit 200 corresponds to the MAC layer and to the higher layers. For the downlink, the physical layer is responsible for extracting the data from the signal UT1 received and for delivering them to the higher layer. For the uplink, the physical layer is responsible for the entire process required for the transmission in the signal UT2 of the data delivered by the higher layer. The MAC layer is responsible for processing the signaling data originating from, or destined for the physical layer, for managing the synchronization, the allocation of bursts, the passband, the real-time constraints between the higher layers and the physical layer, the setting up and the maintaining of the connection with the aid of signaling messages, etc.

For the sake of simplicity, the terminal is considered to be designed for an IB application, that is to say the signal is considered to contain the downstream interactive channel and a downstream payload channel, which are multiplexed on the same carrier. It will simply be noted that in the case of a terminal designed for OOB application, another unit for adaptation to the physical medium (in addition to the unit 100) is required for the reception (comprising the filtering, the demodulation and the decoding) of the signal containing the downstream payload channel.

The downstream interactive channel comprises return signaling data, and in particular an offset parameter referred to as the MAC_OFFSET parameter in the literature. This parameter allows each terminal to clamp (temporally) onto the return channel with respect to the other user terminals of the interactive network, by compensating for the differences of remoteness between the various terminals. It may have a resultant composed of an integer number of symbols and of a decimal part of a symbol. In general, this parameter is related to the frame period of the downstream data flow.

Advantageously, the unit 100 comprises all the means of the terminal that are dependent on the telebroadcasting standard of the system. Stated otherwise, the unit 200 is independent of this standard. When one of the units, or both, are embodied in the form of an electronic circuit, or a respective integrated electronic component, the circuit or the component forming the unit 200 may thus serve in terminals intended to be used in any type of system, that is to say independently of the standard to which the system conforms. Only the unit 100 is specific to the system standard. Economies of scale are thus produced as far as the industrial manufacture of the unit 200 is concerned.

The unit 100 comprises a module 110 for receiving (Rx) the telebroadcast signal UT1. The module 110 affords in particular the function of a demodulator and of an error-correcting filter (FEC). It produces downstream information, which is extracted from the signal UT1.

The downstream information generated by the reception module 110 may be transmitted from the unit 100 to the unit 200 via a specified downstream data interface protocol (DS_I/F). The detailed description of this protocol would exceed the scope of the present description.

The unit 100 comprises a module 120 for generating a transmission time base from the downstream data flow, that is to say from the downstream data contained in the signal UT1. The module 120 comprises for example a digital phase locked loop (DPLL).

In the case for example of an IB application with a standard such as DVB-RCS, the signal UT1 transports a packetized data flow, in particular MPEG2 (“Moving Pictures Expert Group 2”) packets. The headers of these packets contain control information. In particular, certain packets may contain an NCR (“Network Clock Recovery”) field. The NCR field is present a periodically in the downstream data flow. The values of the NCR field have as function to allow the terminal to synchronize itself with the clock of the telebroadcasting network, with a view to affording the processing of the data of the flow of packets and to clocking the transmission of the upstream data over the return channel.

Thus, in a first example valid in particular with regard to systems, which conform to one of the DVS-RCS, NBI, DOCSIS and DVB-RCT standards, the module 120 operates according to a method known as the “NCR counter method”. This method comprises the following steps:

extract the values of the NCR fields (hereinafter NCR values) from the packets of the downstream data flow, and stamp them without introducing temporal jitter despite the a periodic nature of the NCR fields. This stamping is carried out, for example, as a function of the PCR (“Program Clock Reference”) information contained in the headers of the MPEG2 packets;

generate a local clock (or rather a time base) by locally overseeing a clock counter as a function of a stamped NCR values (or “NCR stamp values”), in such a way as to minimize the error between the stamped NCR values and the values of the local counter at the stamping instants;

use the local clock to clamp the clocking of the terminal, taking account of the MAC_OFFSET offset parameter;

use the local clock to synthesize the frequency of the symbols of the upstream data flow;

use the local clock to synthesize the carrier frequency of the upstream channel;

use the local clock to organize and transmit the bursts of upstream data at specified respective instants; and

generate a symbol string adjusted to the local clock, as well as the modulation carrier.

The phase of the symbols should not exceed a given fraction of the period of the local clock within the limits of the burst. In certain cases, this may lead to the position of the burst being adjusted not only to an integer number of periods of the local clock but also to a fraction of the period of the local clock.

In a second example, valid in particular with regard to the systems that conform to one of the ESW, HB6 and DVB-RCT standards, the module 120 operates according to the so-called “frame-by-frame” method. This method consists in establishing a simple relationship between the bit rate of the downstream channel and the bit rate of the upstream channel. For example, the packet bit rate, the symbol bit rate, etc., may be regarded as parameters. The following relationship may then be written:

$$Fout = \frac{P}{Q} \times Fin \qquad ( 1 )$$

where:

Fin is for example the frequency of the packets of the downstream flow;

Fout is for example the bit rate of symbols of the upstream flow; and

P and Q are specified integers.

As with the NCR counter method (first example above), the structure of the upstream data flow is organized into frames. The frame length of the upstream data flow is an integer multiple of the symbol period of the upstream data flow. The frame structure is temporally clamped to the base as a function of the MAC_OFFSET parameter.

In all cases, that is to say whatever the standard of the telebroadcasting system, the module 120 generates a transmission time base Tx_TB which is used to clock the transmission of the signal UT2 over the return channel.

The time base Tx_TB is defined at each instant by the current value of an N-bit counter, that is to say a counter modulo 2^{N}, where N is a specified integer. In an example, N is equal to 64. The counter is clocked by a clock signal Tx_Clk, which is generated by the module 120. In an exemplary embodiment, the counter may be situated in the module 120.

The unit 100 thus comprises a transmission module 130 (Tx) for the return signal UT2, which is clocked as a function of the time base Tx_TB. The module 130 affords in particular the functions of interpolation and of modulation of the symbols to be transmitted. It is preceded by a module 131, which is also clocked as a function of the time base Tx_TB and which affords the function of coding and of formatting the bursts.

The module 131 receives the upstream data from outside the unit 100 via an upstream data interface protocol UPS_I/F. These data are delivered by the unit 200.

Finally, the unit comprises a synchronization interface module 140, whose function is to transmit the time base Tx_TB to the unit 200.

The unit 100 is advantageously embodied in the form of an integrated electronic circuit comprising hardware elements and software elements. In an example, the modules 110, 120, 130, 131 and 140 are embodied in the form of essentially hardware elements. Nevertheless, they may also, in whole or part, be embodied in a form comprising software elements.

The unit 200 advantageously comprises a general-usage processor 210 or host processor, a memory bank 220 forming a shared memory which is used by all the applications of the MAC and higher layers, a downlink coprocessor 230 and an uplink coprocessor 240. These elements are interlinked by a bus 250, for example a broadband bus, such as STbus, supporting transfer rates of the order of several Gigabits (10⁹ bits/s) per second.

A specific function of the coprocessor 240 is to process the operations related to the uplink. In particular, it generates the upstream data which are delivered to the unit 100. In an example, the upstream information is transmitted from the unit 200 to the unit 100 via a specified synchronous upstream data interface protocol UPS_I/F.

Advantageously, the coprocessor 240 is clocked as a function of the transmission time base Tx_TB, thereby reducing the requirement in terms of buffer memories between the coprocessor 240 and the modules 130, 131 and making it possible to increase the bit rate of the data transmission over the return channel. This is why the time base Tx_TB is transmitted, by virtue of the module 140, from the unit 100 to the unit 200 via a specified synchronization interface protocol SYNC_I/F.

In one embodiment, the unit 200 and in particular the coprocessor 240 makes it possible to temporally clamp the delivery of the upstream data to the unit 100 by taking account of the part of the MAC_OFFSET offset parameter corresponding to an integer number of symbols. This is possible since the unit 200 knows the value of the MAC_OFFSET parameter which is received in the downstream data, and since it is moreover synchronized with the transmission time base Tx_TB. Thus, only a slight temporal clamping of the dispatching of the upstream data by the transmission module 130 is performed, on the basis of the symbol decimal part of the MAC_OFFSET parameter, in the unit 100. This allows just-in-time upstream data management.

In an advantageous embodiment, the terminal also comprises a bidirectional bus linking the unit 100 and the unit 200 so as to transmit commands from the unit 200 to the unit 100, or vice versa, via a synchronous control interface protocol CTRL_I/F. More particularly, the bus in question links the coprocessor 240 to the module 131 of the unit 100.

These commands allow the unit 200 to read or write the value of initialization parameters of the physical layer from or to registers of the unit 100. Such parameters are, in particular, information defining the type of coding (e.g. Reed-Solomon or the like), the carrier frequency, the symbol frequency, or the like, which are involved at the physical layer level.

Advantageously, the exchange of commands by virtue of the CTRL_I/F interface protocol makes it possible to manage complicated operational modes. For example, parameters of the physical layer may be modified on the fly from one burst to another.

Such a bus is for example the SRAM bus, which is a bus for synchronous access to memories, well known to the person skilled in the art. It does not seem necessary to detail here the manner of operation of the CTRL_I/F interface protocol in this case, the reader being referred for this purpose to the literature relating to the SRAM bus. It may merely be noted that the transfers over this bus (during operations of reading from or writing to the aforesaid registers of the unit 100) are synchronized with the time base Tx_TB, by assumption.

It will be noted that the transmission of upstream data and the transmission of commands, respectively according to the UPS_I/F protocol and the CTRL_I/F protocol, may take place simultaneously.

The terminal 30 may obviously comprise other means (not represented), in particular, apart from another unit for adaptation to the physical medium (see above), means for processing the data received in the downstream payload channel. Such means may for example comprise an MPEG decoder and associated means when the payload data comprise a transport stream corresponding to an audiovisual program in the MPEG format.

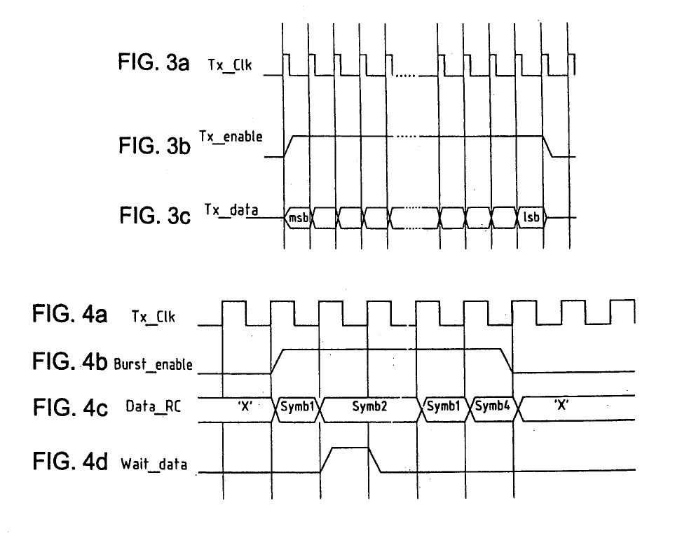

The timing diagrams of FIGS. 3a to 3c give the profile of the signals of the SYNC_I/F interface protocol, during the execution of a synchronization command. This protocol is a three-wire protocol.

The first wire (FIG. 3a) transmits the clock signal Tx_Clk of the transmission time base Tx_TB. The second wire (FIG. 3b) transmits a validation signal Tx_enable. Finally, the last wire (FIG. 3c) transmits the N bits of the value of the counter of the transmission time base Tx_TB in synchronize with the signal Tx_Clk, when the signal Tx_enable is active (that is to say in the high state, in the example represented).

More exactly, a bit is transmitted at each period of the signal Tx_Clk, for example commencing with the least significant bits (or LSB) and ending with the most significant bits (or MSB).

The validation signal Tx_enable is activated when the unit 100 receives a synchronization command coming from the unit 200 via the control interface protocol CTRL_I/F. As a general rule, this occurs once only, at the start of connection. Thereafter, this may occur again, for example should all or part of the unit 100 and/or the unit 200 be reinitialized.

The timing diagrams of FIGS. 4a to 4d give the profile of the signals of the upstream data interface protocol UPS_I/F, during an exemplary transmission of four symbols Symb1 to Symb4 of the module 240 from the unit 200 to the module 131 of the unit 100. This protocol is a 10-wire protocol. For the sake of clarity, the clock signal Tx_Clk is also represented (FIG. 4a) above the signals of the UPS_I/F protocol, although it is not transmitted according to this protocol.

A first wire (FIG. 4b) transmits an activation signal Burst_enable. This signal indicates to the physical layer the date of departure of a burst. Eight other wires referenced jointly Data_RC (FIG. 4c) transmit the symbol values coded on eight bits, at a rate of one symbol per period of the signal Tx_Clk when the signal Burst_enable is active (that is to say in the high state, in the example represented). A tenth and last wire (FIG. 4d) transmits a control signal Wait_data, from the unit 100 to the unit 200.

The signal Wait_data is activated (that is to say in the high state, in the example represented) when the unit 100 does not have enough resources to receive the upstream data, for example because a buffer memory is full. In this case, the symbols which were unable to be delivered to the unit 100 are repeated at the next period of the signal Tx_Clk. In FIGS. 4c and 4d, such a situation is represented by way of example as far as the symbol Symb2 is concerned.

When the signal Burst_enable is inactive, the Data_RC wires are for example in the high-impedance state denoted HZ or ‘X’ in the literature.

Although a specific embodiment of the invention has been disclosed, it will be understood by those having skill in the art that changes can be made to this specific embodiment without departing from the spirit and scope of the invention. The scope of the invention is not to be restricted, therefore, to the specific embodiment, and it is intended that the appended claims cover any and all such applications, modifications, and embodiments within the scope of the present invention.

What is claimed is:

1. A terminal for interactive telebroadcasting system conforming to at least one specified telebroadcasting standard, comprising:
at least one unit for adaptation to a physical medium of a telebroadcasting standard, the unit including:
means for receiving a telebroadcast signal of the telebroadcasting standard so as to produce downstream information extracted from the telebroadcast signal;
means for generating a transmission time base from the downstream information;
means for transmitting a return signal, wherein the return signal is clocked as a function of the transmission time base; and
at least one control unit including a calculation unit having means for generating upstream information, the calculation unit being clocked as a function of the transmission time base.

2. The terminal according to claim 1, further comprising:
means for transmitting the transmission time base from the unit for adaptation to the physical medium to the calculation unit via a specified synchronization interface protocol.

3. The terminal according to claim 2, wherein the transmission time base further comprises:
a counter which is clocked by a clock signal, a value of the counter and the clock signal being transmittable according to the synchronization interface protocol.

4. The terminal according to claim 1, further comprising:
means for transmitting the upstream information from the control unit to the unit for adaptation to the physical medium via a specified synchronous upstream data interface protocol.

5. The terminal according to claim 2, further comprising:
means for transmitting the upstream information from the control unit to the unit for adaptation to the physical medium via a specified synchronous upstream data interface protocol.

6. The terminal according to claim 3, further comprising:
means for transmitting the upstream information from the control unit to the unit for adaptation to the physical medium via a specified synchronous upstream data interface protocol.

7. The terminal according to claim 4, wherein the control unit further comprises:
means for temporally clamping a delivery of the upstream information to the unit for adaptation to the physical medium by taking account of the part corresponding to an integer number of symbols of an offset parameter received in the downstream data.

8. The terminal according to claim 5, wherein the control unit further comprises:
means for temporally clamping a delivery of the upstream information to the unit for adaptation to the physical medium by taking account of the part corresponding to an integer number of symbols of an offset parameter received in the downstream data.

9. The terminal according to claim 6, wherein the control unit further comprises:
means for temporally clamping a delivery of the upstream information to the unit for adaptation to the physical medium by taking account of the part of the upstream information corresponding to an integer number of symbols of an offset parameter received in the downstream data.

10. The terminal according to claim 7, wherein the control unit further comprises:
means for temporally clamping a delivery of the upstream information to the unit for adaptation to the physical medium by taking account of the part of the upstream information corresponding to an integer number of symbols of an offset parameter received in the downstream data.

11. The terminal according to claim 1, further comprising:
means for transmitting commands between the control unit and the unit for adaptation to the physical medium, via a specified synchronous control interface protocol.

12. The terminal according to claim 4, further comprising:
means for transmitting commands between the control unit and the unit for adaptation to the physical medium, via a specified synchronous control interface protocol.

13. The terminal according to claim 7, further comprising:
means for transmitting commands between the control unit and the unit for adaptation to the physical medium, via a specified synchronous control interface protocol.

14. The terminal according to claim 1, wherein the unit for adaptation to the physical medium is embodied in the form of an integrated electronic component.

15. The terminal according to claim 1, wherein the calculation unit for the generation of the upstream information is a first coprocessor.

16. The terminal according to claim 15, wherein the control unit further comprises:
a general-usage processor;
a second coprocessor for processing the downstream data; and
a shared memory, which are linked to the first coprocessor by a bus.

17. A terminal for interactive telebroadcasting system conforming to at least one specified telebroadcasting standard, comprising:
at least one unit for adaptation to a physical medium of a telebroadcasting standard, the unit including:
a receiver module for receiving a telebroadcast signal of the telebroadcasting standard so as to produce a downstream information extracted from the telebroadcast signal;
a time base generator module for generating a transmission time base from the downstream information;
a transmission module for transmitting a return signal, wherein the return signal is clocked as a function of the transmission time base; and
at least one control unit including a calculation unit having means for generating upstream information, the calculation unit being clocked as a function of the transmission time base.
